(19) United States
(12) Patent Application Publication
(10) Pub. No.: US 2021/0149793 A1
(43) Pub. Date: May 20, 2021

(54) WEIGHTED CODE COVERAGE

(71) Applicant: International Business Machines Corporation, Armonk, NY (US)

(72) Inventors: Liujia Shao, Markham (CA); Yan Luo, Concord (CA); Yan Xu, Markham (CA); Anton Karputkin, Thornhill (CA)

(21) Appl. No.: 16/687,968

(22) Filed: Nov. 19, 2019

(51) Int. Cl. G06F 11/36; G06F 8/75; G06K 9/62; G06N 20/00

(52) U.S. Cl. CPC G06F 11/3676; G06F 11/3684; G06N 20/00; G06F 8/75; G06K 9/6256; G06F 11/3688

(57) ABSTRACT

Provided is a method, a system, and a computer program product for determining a cognitive code coverage weight for code snippets located in a portion of code. The method includes generating a set of samples from code snippets included in a portion of code. Each sample in the set of samples includes features derived from the code snippets. The method further includes generating corresponding labels for the set of samples and creating a training dataset by applying the labels to the set of samples. The training dataset includes the set of samples with each sample including a label from the labels generated. The method further includes training a machine learning model using the labeled dataset to output a code coverage weight for code snippets.

### BACKGROUND

The present disclosure relates to code coverage, and more specifically, to providing customized weighted code coverage using machine learning techniques.

During software development, a test case is used to test portions of source code to see how the code behaves during execution. A test suite is a collection of similar test cases designed to test various aspects of the source code. A code coverage report is generated once the test suite is executed on the portion of code. The code coverage report breaks down the portion of code into code snippets and provides a percentage of coverage for each code snippet. Code coverage is a metric used to reflect the degree to which the source code of a code snippet is executed during a test suite operation. Developers can assess the overall quality of a test suite by assessing the amount of coverage across the code snippets.

Typically, predefined rules for a test suite are used to improve the code coverage of a test suite. The predefined rules are program language specific, require domain knowledge, and usually require modification when the programming language version is updated.

### SUMMARY

Embodiments of the present disclosure include a computer-implemented method for determining a cognitive code coverage weight for code snippets located in a portion of code. The computer-implemented method includes generating a set of samples from code snippets included in a portion of code. Each sample in the set of samples includes features derived from the code snippets. The computer-implemented method further includes generating corresponding labels for the set of samples and creating a training dataset by applying the labels to the set of samples. The training dataset includes the set of samples with each sample including a label from the labels generated. The computer-implemented method further includes training a machine learning model using the labeled dataset to output a code coverage weight for code snippets.

Further embodiments are directed to a computer program product for determining a cognitive code coverage weight for code snippets located in a portion of code, which can include a computer readable storage medium having program instructions embodied therewith, the program instructions executable by a processor to cause the processor to perform a method. The method includes generating a set of samples from code snippets included in a portion of code. Each sample in the set of samples includes features derived from the code snippets. The method further includes generating corresponding labels for the set of samples and creating a training dataset by applying the labels to the set of samples. The training dataset includes the set of samples with each sample including a label from the labels generated. The method further includes training a machine learning model using the labeled dataset to output a code coverage weight for code snippets.

Additional embodiments are directed to a cognitive code coverage system for determining a cognitive code coverage weight for code snippets located in a portion of code, including one processing component and at least one memory component. The system also includes a feature extractor configured to extract features from code snippets located in a portion of code. The features include software metrics taken from the code snippets. The system also includes a label generator configured to generate corresponding labels for the features extracted from the code snippets. The labels are code coverage weights for the code snippets where the weights identify the importance, or priority, of the code snippet being labeled. A test suite can utilize the weights to ensure that the code snippets are tested according to their weight. The system further includes a machine learning model configured to output a priority-based weight for a code snippet upon being trained with a training dataset generated from the features and the labels.

### BRIEF DESCRIPTION OF THE DRAWINGS

These and other features, aspects, and advantages of the embodiments of the disclosure will become better understood with regard to the following description, appended claims, and accompanying drawings where:

FIG. 1 is a block diagram illustrating a cognitive code coverage system, in accordance with embodiments of the present disclosure.

FIG. 2 is a flow chart of a machine learning training process, in accordance with embodiments of the present disclosure.

FIG. 3 is a high-level block diagram illustrating an example computer system that may be used in implementing one or more of the methods, tools, and modules, and any related functions, described herein, in accordance with embodiments of the present disclosure.

FIG. 4 depicts a cloud computing environment, in accordance with embodiments of the present disclosure.

FIG. 5 depicts abstraction model layers, in accordance with embodiments of the present disclosure.

While the present disclosure is amenable to various modifications and alternative forms, specifics thereof have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numeral are used to designate like parts in the accompanying drawings.

### DETAILED DESCRIPTION

The present disclosure relates to code coverage, and more specifically, to providing customized weighted code coverage using machine learning techniques. While the present disclosure is not necessarily limited to such application, various aspects of the disclosure may be appreciated through a discussion of various examples using this context.

A test suite is a collection of test cases designed to test a software program when at least some portion of software development is complete. A test suite includes a collection of test cases where each test case is some script designed to validate whether or not a portion of code is working correctly.

A test case is typically a script of inputs, execution conditions, testing procedures, and expected results intended to be executed on some portion of code to achieve an objective. Once executed, a test case can validate whether or not the portion of code is in compliance and operating correctly. A test suite is a collection of test cases designed to test a software program when software development is complete on a portion of code. Test suites can be used for various types of tests such as build verification tests, smoke tests, end-to-end integration tests, and functional verification tests. Based on the type of testing, a coverage report can be generated to measure what percentage of code has been executed by the test suite.

To measure the percentage of code executed by a test suite, one or more coverage criteria is used to generate the code coverage report. The types of coverage criteria include function coverage, statement coverage, edge coverage, branch coverage, condition coverage, and the like. Software developers can select the type of coverage criteria to use based on the code being tested.

Software developers can analyze the code coverage report to devise additional tests and configurations to increase the code coverage of critical functions during testing. The additional test cases can either be generated automatically or manually written. Automatically generated test cases may not be accurate enough to improve coverage of critical code and manually written test cases can become time consuming to write. Other traditional techniques to improve code coverage include deleting unnecessary code, removing redundant code, and writing sophisticated tests to cover areas of need.

Embodiments of the present disclosure may overcome the above, and other, problems by using a cognitive code coverage system. The cognitive code coverage system is configured to receive a portion of programming code segmented into code snippets and to derive samples from the code snippets. Each sample generated from the code snippets include features derived from the source code using various software metrics. The cognitive code coverage system is further configured to generate labels for each of the samples by analyzing historical development data. The cognitive code coverage system is also configured to generate a labeled dataset by combining the samples with the labels. The labeled dataset can then be used to train a machine learning model to output a priority-based weight for a code snippet relating to the testing importance a code snippet has.

More specifically, the cognitive code coverage system described herein trains a machine learning model to output weights pertaining to a testing importance a code snippet has during a test suite analysis. In other words, the cognitive code coverage system provides weights to code snippets that a test suite can use to factor in how much testing should be performed on a particular code snippet. A code snippet with a low weight may receive a low priority by the test suite. Similarly, a code snippet with a high weight may receive a high priority by the test suite to ensure that the code snippet is adequately tested.

By way of example, a portion of code having multiple code snippets is received by the cognitive code coverage system. In this example, assume that the portion of code includes code snippets A, B, and C. The cognitive code coverage system can analyze each code snippet to provide a weight relating to the importance in testing for that particular code snippet. Further assume that code snippets A and C contain code that is routine and reliable. However, code snippet B contains code that is extensive and complicated. In this instance, the cognitive code coverage system can determine that code snippets A and C are of a low priority and are given relatively low weights. Code snippet B is of a high priority and is given a correspondingly high weight. Once weighed, the portion of code can be tested by a test suite which can utilize the weights given by the cognitive code coverage system when testing the portion of code.

In some embodiments, labeled dataset is divided into a training dataset and a validation dataset. During the training cycle, the machine learning model is trained on the training dataset using a machine learning algorithm (e.g., gradient descent, stochastic gradient descent, etc.) The training dataset includes features and corresponding labels for each sample included in the training dataset. Based on the result outputted by the machine learning model, the parameters of the model can be adjusted. The validation dataset can be used to evaluate the machine learning model trained on the training dataset when adjusting the hyperparameters related to the machine learning model. The validation dataset can also be used for regularization to avoid overfitting by the machine learning model to the training dataset.

In some embodiments, the labels generated by the cognitive code coverage system are provided by examining prior code coverage reports from prior development cycles. Developers may implement a continuous delivery approach to produce software. One common approach is a development and operations (DevOps) pipeline technique to ensure that programming code and infrastructure are always in a deployable state. After each development cycle, DevOps pipeline techniques provide a code coverage report and any known errors detected in the software. By examining the prior code coverage reports, and the detected errors, the cognitive code coverage system can generate a label for the samples.

For example, a code coverage report can include code snippets with code coverage percentages for each code snippet. A comparison can be made between the samples and the code snippets found in prior code coverage reports. The code coverage percentages relating to code snippets similar to the samples can be used as labels for the corresponding samples.

In some embodiments, software metrics and measurements are used to determine the features for each of the samples. A software metric is a standard of measure of a degree to which source code possesses some property. A software measurement is a quantified attribute of a characteristic of the source code. The cognitive code coverage system can evaluate the code snippet relating to each sample and use software metrics and measurements to derive features that can be used by the machine learning model. Examples of software metrics and measurements include lines of source code, comments, the number of files, the number of functions, bugs per line of code, cohesion, static analysis, call references, cyclomatic complexity, design structure quality index (DSQI), function points, instruction path length, maintainability index, program execution time, program load time, program size, weighted micro function points, and the like.

In some embodiments, static analysis is used as a software metric by the cognitive code coverage system. Static analysis, or static code analysis, provides a measurement of the source code structure without executing the code. Static analysis includes a number of lines of source code, a program complexity index, program maintainability index, abstract interpretation, data-flow analysis, model checking, symbolic execution, and the like.

In some embodiments, recent modification information is used as a software metric by the cognitive code cover system. Recent modification information provides information relating to modifications performed on the source from a given time period until testing. Recent modification information includes added lines of code, modified lines of code, added variable, added or deleted functionality, and the like.

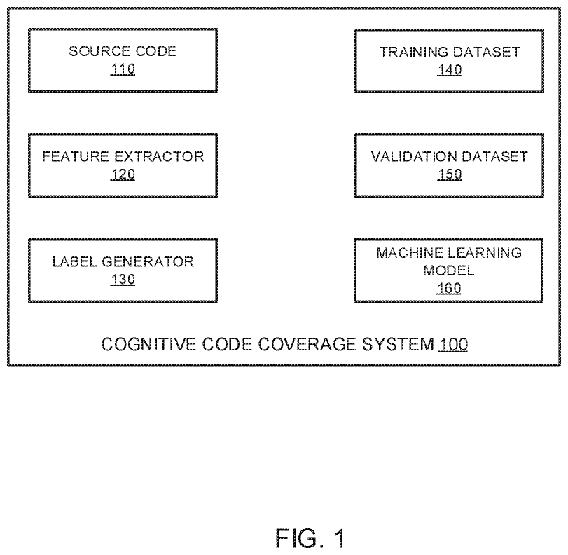

FIG. 1 is a block diagram illustrating a cognitive code coverage system 100, in accordance with embodiments of the present disclosure. The code coverage system 100 includes source code 110, a feature extractor 120, a label generator 130, a training dataset 140, a validation dataset 150, and a machine learning model 160.

The source code 110 is a collection of code written using a human-readable programming language provided to the cognitive code coverage system 100 for analysis. The source code can be segmented into code snippets that can be used as input into the machine learning model 160. A code snippet refers to a portion of re-usable source code defined as defined operative units which make up a larger programming module. Types of code snippets include static snippet, dynamic snippets, scriptable snippets, and the like.

The source code 110 can be written in various types of programming languages. For example, the types of programming languages include Python, Java, Ruby, JavaScript, C, C++, C#, Objective-C, Hypertext Preprocessor (PHP), Structured Query Language (SQL), Swift, BASIC, TypeScript, R, Perl, Kotlin, Rust, Scheme, Erlang, Scala, Haskell, and the like.

The feature extractor 120 is a component of the cognitive code coverage system 100 configured to extract features from code snippets located in the source code 110, in accordance with embodiments of the present disclosure. The feature extractor 120 utilizes software metrics and measurements taken from the code snippets to generate features. A feature is an input variable used by the machine learning model 160 in making predictions. A feature vector is a collection of feature values that represent a sample that is passed into the machine learning model 160. The feature extractor 120 is configured to determine features which can be used to represent the sample derived from the code snippet. For example, a code snippet may include features such as lines of source code, comments, the number of files, the number of functions, bugs per line of code, cohesion, static analysis, and the like. These features can make up the feature vector for the sample generated from the code snippet. Typically, features are numeric, but structural features such as strings and graphs can also be used as features. For example, a code snippet including thirty lines of comments may be represented as a numeric value of thirty, or as a string value for which the comments can be used in natural language processing or syntactic pattern recognition.

In some embodiments, the feature extractor 120 utilizes static analysis features to extract the features from a code snippet. Static analysis provides features such as number of lines of source code, a program complexity index, program maintainability index, abstract interpretation, data-flow analysis, model checking, symbolic execution, and the like.

The label generator 130 is a component of the cognitive code coverage system 100 configured to provide a label for the samples generated by the feature extractor 120, in accordance with embodiments of the present disclosure. A label is the expected result portion of a sample given the provided features. A label can typically include one or more meaningful features that are informative regarding the sample. For example, a label can be a weight pertaining to a testing importance related to a code snippet of source code. The weight can be considered by a test suite during testing of the code snippet. In some embodiments, the label generator 130 utilizes historical code coverage reports to generate a label for the sample that is based on the features extracted. For example, prior development cycles may produce a code coverage report after every development cycle conducted. The development cycles can provide insight as to the prior code coverages and any errors detected during testing. The label generator 130 can generate a weight for a code snippet by analyzing the code coverage of previously tested code snippets to the code snippet being generated a label.

The training dataset 140 is a set of data used to initially train the machine learning model 160, in accordance with embodiments of the present disclosure. The training dataset 140 include a group of data samples, or samples, that have been assigned with one or more labels generated by the label generator 130. Training is a process of determining the ideal parameters comprising the machine learning model 160. The parameters are configuration variables that are internal to the model and whose value can be estimated from the input. For example, if the machine learning model 160 implements a statistical method in making a determination, then the parameter may include a Gaussian distribution parameter and a standard deviation parameter. Other examples of parameters include, but are not limited to, support vectors and coefficients in a liner regression model.

The validation dataset 150 is a set of data used to validate the training proficiency of the machine learning model 160, in accordance with embodiments of the present disclosure. Validation is a process used, as part of training, to evaluate the quality of the machine learning model 160 using the validation dataset 150. By having the validation dataset 150 separate from the training dataset 140, the validation process can help to ensure that the performance of the machine learning model 160 generalizes beyond the training set.

The machine learning model 160 is a component of the cognitive code coverage system 100 configured to output a priority-based weight for a code snippet, in accordance with embodiments of the present disclosure. The machine learning model 160 can employ various machine learning techniques to determine a weight for a code snippet. Machine learning techniques can comprise algorithms or models that are generated by performing supervised, unsupervised, or semi-supervised training on a dataset, and subsequently applying the generated algorithm or model to generate a priority-based weight for a code snippet. Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

The machine learning model 160 can evaluate the feature vectors within the training dataset 140 to consider whether a particular code snippet has characteristics that are indicative of a code snippet of higher priority. These characteristics include, but are not limited to, edge-case branch code, complex buffer capacity check code, the frequency of comments, and similarity of previously tested code.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

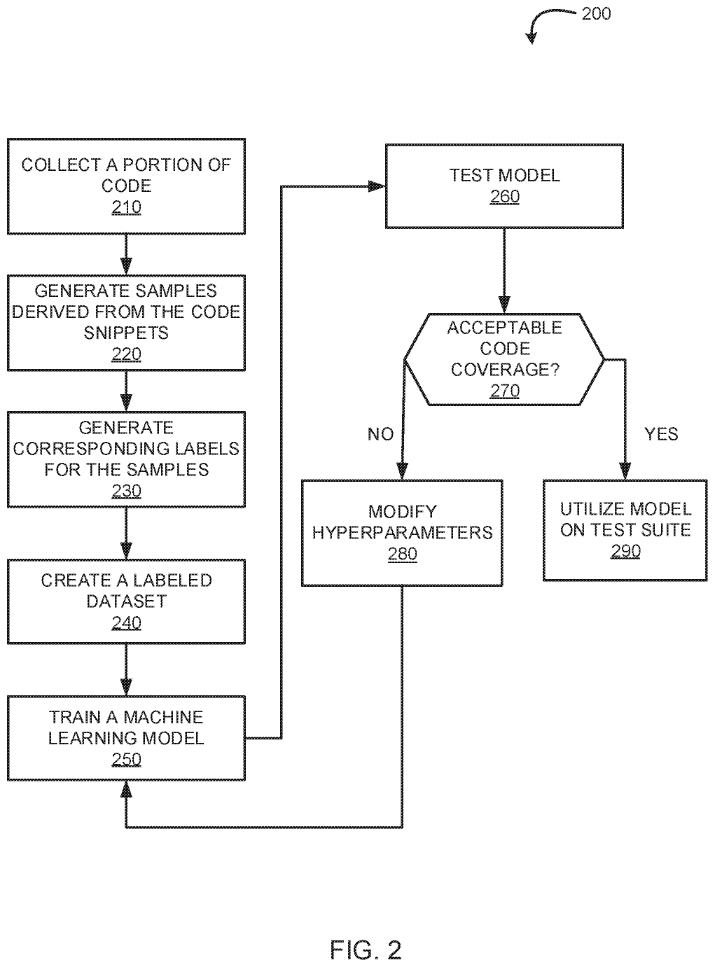

FIG. 2 is a flow diagram illustrating a process 200 of determining a cognitive code coverage weight for code snippets located in a portion of code, in accordance with embodiments of the present disclosure. The process 200 may be performed by hardware, firmware, software executing on a processor, or a combination thereof. For example, any or all of the steps of the process 200 may be performed by one or more processors embedded in a computing device.

A portion of code is collected by the cognitive code coverage system 100. This is illustrated at step 210. In some embodiments, the portion of code is collected as an input into the code coverage system 100 as part of a module within a test suite application. In some embodiments, the portion of code is retrieved from a storage device locally stored on a computing device that is executing the cognitive code coverage system 100. For example, the cognitive code coverage system 100 may be tasked to determine weights for a portion of code that has been previously tested by a test suite. The cognitive code coverage system 100 can collect the portion of code from the test suite for evaluation.

The portion of code is made from code snippets of source code 110 to perform some task. For example, the portion of code can be source code for an application and each code snippet can be some task the application can perform. The code snippets can vary from routine actions to advanced actions that are fundamental to the performance of the portion of code. A pattern analysis can be performed on previously tested code to determine whether a code snippet is routine or advanced. For example, a code snippet matching a pattern of a previously tested code snippet with a high code coverage value can be considered as advanced. Alternatively, if the code snippet matches a previously tested code snippet with a low code coverage value, then that can be indicative that the code snippet is routine.

The feature extractor 120 extracts features from the code snippets to generates samples. This is illustrated at step 220. Each code snippet comprises source code to perform some action or function. The feature extractor 120 can apply software metrics to the code snippets to derive features that may be pertinent to the code snippet. For example, software metrics can be applied to a code snippet to determine the number of lines of source code per code snippet, comments developers inserted into a code snippet, call references, function points, instruction path length, and the like.

In some embodiments, the features extracted by the feature extractor 120 are devised by an individual or administrator. For example, statistical analysis features, TF-IDF, word embedding, embedding layer of a recurrent neural network (RNN), and the like, are features that can be useful to the machine learning model 160 in determining a priority-based weight for a code snippet.

The label generator 130 generates corresponding labels for the samples. This is illustrated at step 230. Each sample has unique attributes, or features, which can be analyzed by the label generator 130 to determine an appropriate label. As a portion of code goes through development cycles, code coverage reports are generated by test suites which include code coverages for code snippets located in the portion of code. The label generator 130 can compare the features of the prior code snippets in the code coverage report to the features of the samples provided by the feature extractor 120. Once a similar prior code snippet is determined, the code coverage provided to that code snippet can be used as a label for the sample.

In some embodiments, the code coverage reports analyzed are not prior code coverage reports for the portion of code. For example, a developer may maintain a repository of code coverage reports that the label generator 130 can access. The repository can include code coverage reports from a wide array of source code and applications which can be written in a variety of programming languages. For example, a code coverage report may be for a portion of code written in C while another code coverage report may be for a portion of code written in Java.

A labeled dataset is created from the samples and labels produced by the feature extractor 120 and the label generator 130. This is illustrated at step 240. The labeled dataset includes a sample for each code snippet included in the portion of code and a corresponding label. For example, the feature extractor 120 can extract features from a code snippet that includes the number of lines of source code, program load time, instruction path length, and program execution time to produce a sample. The sample having the extracted features taken from the code snippet. The label generator 130 can analyze those features and compare them to code snippets in prior code coverage reports. Upon locating a similar code snippet with similar features, the code coverage of the prior code snippet can be used as a label for the sample. The labels and samples for the portion of code can be combined to create the labeled dataset. Once created, the labeled dataset can be used a training dataset 140 to train the machine learning model.

In some embodiments, the labeled dataset is split into the training dataset 140 and the validation dataset 150. Depending on the training conducted on the machine learning model 160, a portion of the labeled dataset can be allocated to the validation dataset 150 to prevent overfitting by the machine learning model 160 to the training dataset 140.

The labeled dataset is used to train the machine learning model 160. This is illustrated at step 250. The machine learning model 160 can be trained with the labeled dataset using various supervised machine learning techniques and algorithms. The algorithm and technique used by the machine learning model 160 can be selected to minimize bias, variance, function complexity, dimensionality of the input space, and noise. Other factors, such as heterogeneity of the labeled dataset, redundancy in the labeled dataset, and presence of interactions and non-linearities can be used to determine which algorithm to use to train the machine learning model 160. Once a machine learning algorithm is selected, the machine learning model 160 is trained to learn the task of determining a priority-base weight for code snippets inputted into the model 160. The machine learning model 160 can analyze the labeled dataset and produced an inferred function, which can be used for mapping new samples.

In some embodiments, the labeled dataset is split into a training dataset and a validation dataset. The training dataset can be used to initially train the machine learning model 160. The validation dataset can be used to initially vet the machine learning model 160.

The machine learning model 160 is tested to determine the accuracy and reliability of the output produced. This is illustrated at step 260. A test dataset can be used to test the machine learning model 160 after training has been performed. Testing can occur through various methods such as holdout and cross-validation. The holdout method includes testing the machine learning model 160 where the test dataset is separate and apart from the training dataset. The cross-validation method involves partitioning the labeled dataset into the training dataset 140 and validation dataset 150. In some embodiments, testing is performed using the cross-validation method using a k-fold cross-validation technique. For example, a five-fold cross validation test involves having the labeled dataset being partitioned into five parts of approximately equal size. The machine learning model 160 can be trained with four of the partitions and tested with the fifth partition. This can be repeated for each of the partitions where each partition is rotated to become the test dataset. Once trained, an estimation of accuracy is averaged over the five training sessions to get a total effectiveness of the machine learning model 160.

Additionally, the machine learning model 160 can be evaluated using various model evaluation metrics. Model evaluation metrics can include Jaccard index, confusion matrix, F-1 score, logarithmic loss, classification accuracy, area under curve, mean absolute error, mean squared error, and the like. Once evaluated, a determination is made as to whether the accuracy of the machine learning model 160 is acceptable. This is illustrated at step 270. If the performance of the machine learning model is below a predefined threshold, then the process 200 can proceed to step 280. However, if the performance of the machine learning model exceeds or reaches the predefined threshold, then the machine learning model 160 can be utilized with a test suite. This is illustrated at step 290.

If the performance of the machine learning model 160 fails to exceed a predefined threshold of performance, then adjustments can be made to improve the accuracy of the machine learning model 160. This is illustrated at step 280. Depending on the machine learning algorithm used by the machine learning model 160, adjustments to various hyperparameters can be made. A hyperparameter is a parameter of the machine learning model 160 that can be adjusted prior to and during successive training sessions. Types of hyperparameters include learning rate, regularization, minibatch size, number of epochs, number of hidden units, and the like. For example, the learning rate can be adjusted depending on the number of epochs needed to reach an ideal state. If the learning rate is too small, then the optimal value would take a much longer time. On the other hand, if the learning rate is too large, then the optimal value would overshoot the ideal state. Once the hyperparameters are adjusted by an administrator, the machine learning model can be retrained as illustrated at step 250.

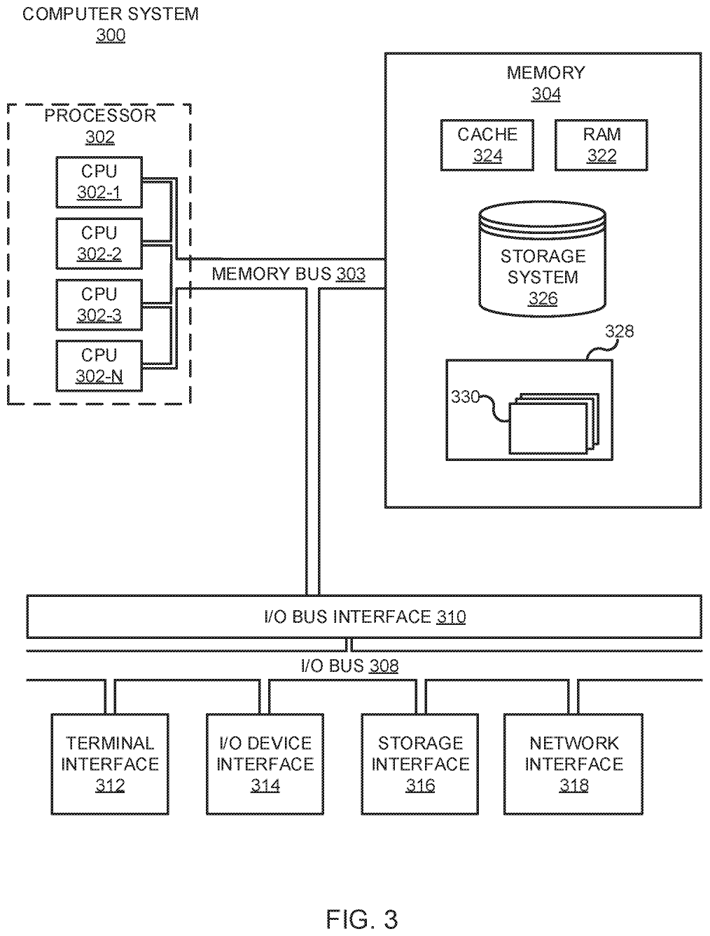

Referring now to FIG. 3, shown is a high-level block diagram of an example computer system 300 (e.g., code coverage system 100) that may be used in implementing one or more of the methods, tools, and modules, and any related functions, described herein (e.g., using one or more processor circuits or computer processors of the computer), in accordance with embodiments of the present disclosure. In some embodiments, the major components of the computer system 300 may comprise one or more processors 302, a memory 304, a terminal interface 312, a I/O (Input/Output) device interface 314, a storage interface 316, and a network interface 318, all of which may be communicatively coupled, directly or indirectly, for inter-component communication via a memory bus 303, a I/O bus 308, and an I/O bus interface 310.

The computer system 300 may contain one or more general-purpose programmable central processing units (CPUs) 302-1, 302-2, 302-3, and 302-N, herein generically referred to as the processor 302. In some embodiments, the computer system 300 may contain multiple processors typical of a relatively large system; however, in other embodiments the computer system 300 may alternatively be a single CPU system. Each processor 302 may execute instructions stored in the memory 304 and may include one or more levels of on-board cache.

The memory 304 may include computer system readable media in the form of volatile memory, such as random-access memory (RAM) 322 or cache memory 324. Computer system 300 may further include other removable/non-removable, volatile/non-volatile computer system storage media. By way of example only, storage system 326 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, the memory 304 can include flash memory, e.g., a flash memory stick drive or a flash drive. Memory devices can be connected to memory bus 303 by one or more data media interfaces. The memory 304 may include at least one program product having a set (e.g., at least one) of program modules that are configured to carry out the functions of various embodiments.

Although the memory bus 303 is shown in FIG. 3 as a single bus structure providing a direct communication path among the processors 302, the memory 304, and the I/O bus interface 310, the memory bus 303 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 310 and the I/O bus 308 are shown as single respective units, the computer system 300 may, in some embodiments, contain multiple I/O bus interface units, multiple I/O buses, or both. Further, while multiple I/O interface units are shown, which separate the I/O bus 308 from various communications paths running to the various I/O devices, in other embodiments some or all of the I/O devices may be connected directly to one or more system I/O buses.

In some embodiments, the computer system 300 may be a multi-user mainframe computer system, a single-user system, or a server computer or similar device that has little or no direct user interface but receives requests from other computer systems (clients). Further, in some embodiments, the computer system 300 may be implemented as a desktop computer, portable computer, laptop or notebook computer, tablet computer, pocket computer, telephone, smart phone, network switches or routers, or any other appropriate type of electronic device.

It is noted that FIG. 3 is intended to depict the representative major components of an exemplary computer system 300. In some embodiments, however, individual components may have greater or lesser complexity than as represented in FIG. 3, components other than or in addition to those shown in FIG. 3 may be present, and the number, type, and configuration of such components may vary.

One or more programs/utilities 328, each having at least one set of program modules 330 may be stored in memory 304. The programs/utilities 328 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 328 and/or program modules 330 generally perform the functions or methodologies of various embodiments.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

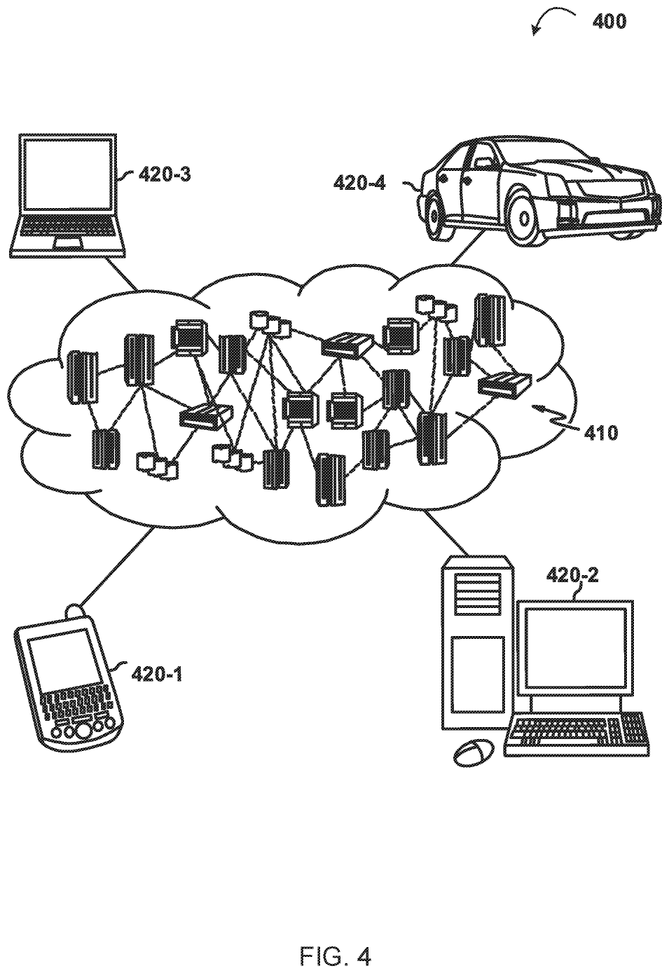

Referring now to FIG. 4, illustrative cloud computing environment 400 is depicted. As shown, cloud computing environment 400 includes one or more cloud computing nodes 410 with which local computing devices used by cloud consumers, such as, for example, personal digital assistant (PDA) or cellular telephone 420-1, desktop computer 420-2, laptop computer 420-3, and/or automobile computer system 420-4 may communicate. Nodes 410 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 420-1 to 420-4 shown in FIG. 4 are intended to be illustrative only and that computing nodes 10 and cloud computing environment 400 can communicate with any type of computerized device over any type of network and/or network addressable connection (e.g., using a web browser).

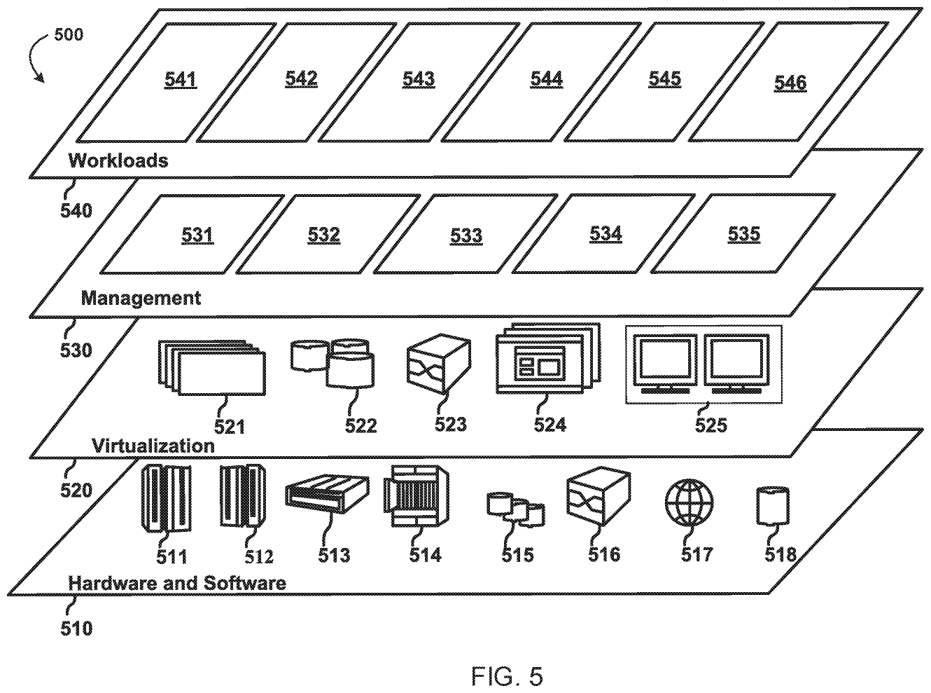

Referring now to FIG. 5, a set of functional abstraction layers 500 provided by cloud computing environment 400 (e.g., FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 510 includes hardware and software components. Examples of hardware components include: mainframes 511; RISC (Reduced Instruction Set Computer) architecture-based servers 512; servers 513; blade servers 514; storage devices 515; and networks and networking components 516. In some embodiments, software components include network application server software 517 and database software 518.

Virtualization layer 520 provides an abstraction layer from which the following examples of virtual entities may be provided: virtual servers 521; virtual storage 522; virtual networks 523, including virtual private networks; virtual applications and operating systems 524; and virtual clients 525.

In one example, management layer 530 may provide the functions described below. Resource provisioning 531 provides dynamic procurement of computing resources and other resources that are utilized to perform tasks within the cloud computing environment. Metering and Pricing 532 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 533 provides access to the cloud computing environment for consumers and system administrators. Service level management 534 provides cloud computing resource allocation and management such that required service levels are met. Service Level Agreement (SLA) planning and fulfillment 535 provide pre-arrangement for, and procurement of, cloud computing resources for which a future requirement is anticipated in accordance with an SLA.

Workloads layer 540 provides examples of functionality for which the cloud computing environment may be utilized. Examples of workloads and functions which may be provided from this layer include: mapping and navigation 541; software development and lifecycle management 542; virtual classroom education delivery 543; data analytics processing 544; transaction processing 545; and weighted code coverage processing 546 (e.g., cognitive code coverage system 100).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for optimizing code coverage, the computer-implemented method comprising:
generating a set of samples from code snippets included in a portion of code, wherein each sample in the set of samples includes features;
generating corresponding labels for the set of samples;
creating a training dataset by applying the labels to the set of samples, wherein the training dataset includes the set of samples with each sample including a label from the labels generated; and
training a machine learning model using the labeled dataset to output code coverage weights for other code snippets.

2. The computer-implemented method of claim 1, wherein the features include static code analysis features, wherein the static analysis features include a number of lines of source code, a program complexity index, and program maintainability index.

3. The computer-implemented method of claim 1, wherein the features include recent modification information, wherein the recent modification information includes added lines of code, and modified lines of code.

4. The computer-implemented method of claim 1, wherein generating the corresponding labels comprises:
receiving prior coverage reports;
detecting prior code snippets in the prior coverage reports similar to the samples;
retrieving the code coverages for the prior code snippets; and
producing the corresponding labels for the set of samples, wherein the corresponding labels are the code coverages retrieved from the prior code snippets.

5. The computer-implemented method of claim 4, wherein the prior coverage reports are from prior development cycles of the portion of code.

6. The computer-implemented method of claim 1, further comprising:
preprocessing a second portion of code to generate a second set of samples, wherein each sample in the second set of samples include a second set of features;
inputting the second set of samples into the machine learning model; and
outputting, by the machine learning model, a customized code coverage for the code snippets located in the second portion of code.

7. The computer-implemented method of claim 6, wherein the customized code coverage includes a weight for each code snippet in the second portion of code which indicates a priority for testing.

8. A computer program product comprising a computer readable medium having program instructions embodied therewith, the program instructions executable by a processor to cause the processor to perform a method comprising:
generating a set of samples from code snippets included in a portion of code, wherein each sample in the set of samples includes features;
generating corresponding labels for the set of samples;
creating a training dataset by applying the labels to the set of samples, wherein the training dataset includes the set of samples with each sample including a label from the labels generated; and
training a machine learning model using the labeled dataset to output code coverage weights for other code snippets.

9. The computer program product of claim 8, wherein the features include static code analysis features, wherein the static analysis features include a number of lines of source code, a program complexity index, and program maintainability index.

10. The computer program product of claim 8, wherein the features include recent modification information, wherein the recent modification information includes added lines of code, and modified lines of code.

11. The computer program product of claim 8, wherein generating the corresponding labels comprises:
receiving prior coverage reports;
detecting prior code snippets in the prior coverage reports similar to the samples;
retrieving the code coverages for the prior code snippets; and
producing the corresponding labels for the set of samples, wherein the corresponding labels are the code coverages retrieved from the prior code snippets.

12. The computer program product of claim 11, wherein the prior coverage reports are from prior development cycles of the portion of code.

13. The computer program product of claim 8, further comprising:
preprocessing a second portion of code to generate a second set of samples, wherein each sample in the second set of samples includes a second set of features;
inputting the second set of samples to the machine learning model; and
outputting, by the machine learning model, a customized code coverage for the second portion of code.

14. The computer program product of claim 13, wherein the customized code coverage includes a weight for each code snippet in the second portion of code which indicates a priority for testing.

15. A cognitive code coverage system comprising:
at least one processor;
at least one memory component;
a feature extractor configured to extract features from code snippets located in a portion of code, wherein the features include software metrics taken from the code snippets;
a label generator configured to generate corresponding labels for the features extracted from the code snippets, wherein the labels are code coverage weights; and
a machine learning model configured to output a priority-based weight for a code snippet upon being trained with a training dataset generated from the features and the labels.

16. The cognitive code coverage system of claim 15, wherein the features include static code analysis features, wherein the static analysis features include a number of lines of source code, a program complexity index, and program maintainability index.

17. The cognitive code coverage system of claim 15, wherein the features includes recent modification information, wherein the recent modification information includes added lines of code, and modified lines of code.

18. The cognitive code coverage system of claim 15, wherein the label generator generates the corresponding labels based upon prior code snippets located in prior code coverage reports.

19. The cognitive code coverage system of claim 18, wherein the prior code coverage reports are from prior development cycles of the portion of code.

20. The cognitive code coverage system of claim 15, wherein the priority-based weight indicates a priority of testing for the code snippet.
